(19) United States
(12) Patent Application Publication
(10) Pub. No.: US 2026/0072974 A1
(43) Pub. Date: Mar. 12, 2026

(54) SYSTEM AND METHOD FOR EXTRACTING MULTIPLE-SENTENCE CHARACTERISTICS

(71) Applicant: SK hynix Inc., Gyeonggi-do (KR)

(72) Inventor: Siarhei ZALIVAKA, Gdansk (PL)

(21) Appl. No.: 19/015,450

(22) Filed: Jan. 9, 2025

Related U.S. Application Data
(60) Provisional application No. 63/693,959, filed on Sep. 12, 2024.

(51) Int. Cl. G06F 16/35

(52) U.S. Cl. CPC G06F 16/35

(57) ABSTRACT

A system for analyzing technical documents for storage devices and extracting multiple-sentence characteristics. The system includes: a plurality of classifiers, each classifier configured to receive multiple sentences from the technical document and generate multi-labels for the multiple sentences, each label indicating whether each sentence has a target characteristic described in the technical document; and an ensemble neural network configured to sequentially receive, as training datasets, multiple multi-labels from the plurality of classifiers, and generate, as a result of training, multiple labels for the multiple sentences based on the training datasets. Each of the plurality of classifiers is configured to receive text fragments at different datapoints corresponding to the multiple sentences with different context window sizes, and generate the multi-labels corresponding to the text fragments.

### CROSS-REFERENCE TO RELATED APPLICATION(S)

This application claims the benefit of U.S. Provisional Application No. 63/693,959, filed on Sep. 12, 2024, the entire contents of which are incorporated herein by reference.

### BACKGROUND

### 1. Field

Embodiments of the present disclosure relate to analysis of technical documents for a storage device.

### 2. Description of the Related Art

The development of storage devices such as a solid state drive (SSD) is a sophisticated process, as it requires expertise in stages of integrated circuit design and verification, firmware development and testing, software simulations and algorithm design, etc. Most of the stages demand a thorough understanding of various technical documents, e.g., specifications, datasheets, user guides, product manuals, etc. As a result, the final product is based on a significant number of characteristics extracted from the technical documents. With advanced natural language processing tools, this activity can be automated to save valuable time of engineers. Technical documents analysis techniques that have been considered are usually applicable to short, sequential and fixed amounts of text (sentence, paragraph), which are processed with a binary classifier. It is in this context that embodiments of the invention arise.

### SUMMARY

Aspects of the present invention include a system and a method for analyzing technical documents for storage devices and extracting multiple-sentence characteristics.

In one aspect of the present invention, a system for analyzing at least one technical document for a storage device includes: a plurality of classifiers, each classifier configured to receive multiple sentences from the technical document and generate multi-labels for the multiple sentences, each label indicating whether each sentence has a target characteristic described in the technical document; and an ensemble neural network configured to sequentially receive, as training datasets, multiple multi-labels from the plurality of classifiers, and, as a result of training, generate multiple labels for the multiple sentences based on the training datasets. Each of the plurality of classifiers is configured to receive text fragments at different datapoints corresponding to the multiple sentences with different context window sizes, and generate the multi-labels corresponding to the text fragments.

In one aspect of the present invention, a method for analyzing at least one technical document for a storage device includes: receiving, by each of a plurality of classifiers, multiple sentences from the technical document and generating multi-labels for the multiple sentences, each label indicating whether each sentence has a target characteristic described in the technical document; sequentially receiving, by an ensemble neural network, multiple multi-labels from the plurality of classifiers as training datasets; and generating, as a result of training the ensemble neural network, multiple labels for the multiple sentences based on the training datasets. The receiving of the multiple sentences includes receiving, by each of the plurality of classifiers, text fragments at different datapoints corresponding to the multiple sentences with different context window sizes, and generating the multi-labels corresponding to the text fragments.

Additional aspects of the present invention will become apparent from the following description.

### BRIEF DESCRIPTION OF THE DRAWINGS

FIG. 1 is a diagram illustrating a documents analysis system and a system on a chip (SoC) verification system in accordance with one embodiment of the present invention.

FIG. 2 is a diagram illustrating a documents analysis system with a plurality of multi-label classifiers in accordance with one embodiment of the present invention.

FIG. 3 illustrates a multi-label classifier in accordance with one embodiment of the present invention.

FIG. 4 is a diagram illustrating an example of a documents analysis system with multiple multi-label classifiers in accordance with one embodiment of the present invention.

FIG. 5 is a diagram of a neural network in accordance with one embodiment of the present invention.

FIGS. 6A to 7B illustrate an example of data extraction from M-PHY specification in accordance with one embodiment of the present invention.

FIGS. 8A and 8B illustrate the performance of trained classifiers depending on context window size in accordance with one embodiment of the present invention.

FIG. 9 is a flowchart illustrating a documents analysis method in accordance with one embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not have been described in detail.

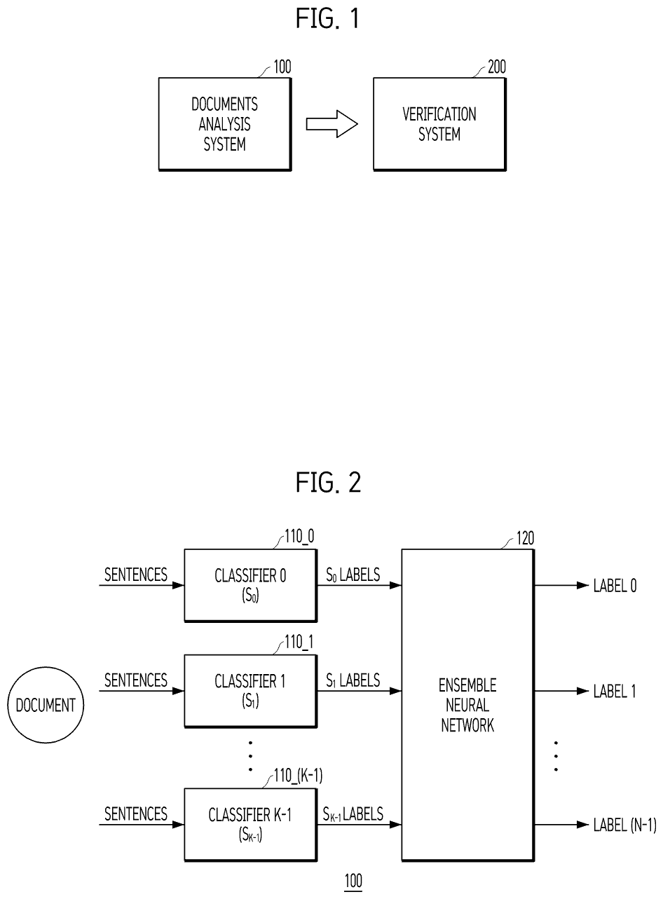

FIG. 1 is a diagram illustrating a documents analysis system 100 and a verification system 200 in accordance with one embodiment of the present invention.

Referring to FIG. 1, the documents analysis system 100 may analyze a technical document to be used for verifying a designed system (e.g., system on a chip (SoC)). In various embodiments, the designed system may be IP components of storage devices such as NAND flash memory devices, e.g., Solid State Drive (SSD), Embedded MultiMedia Card (eMMC), Open NAND Flash Interface (ONFi), Universal Flash Storage (UFS), a low-power Mobile Industry Processor Interface (MIPI) Physical Layer (M-PHY), Non-Volatile Memory express (NVMe), etc. In various embodiments, the technical document may include at least one of a specification, a datasheet, a product manual, and a user guide.

The documents analysis system 100 may provide the verification system 200 with the analysis result. The verification system 200 may receive the analysis result from the documents analysis system 100, and perform a verification process on the designed system based on the analysis result. The verification system 200 may verify whether the designed system meets the requirements described in a technical document for the designed system. The analysis results obtained from documents analysis system 100 may be also used by verification engineers in order to design verification system 200.

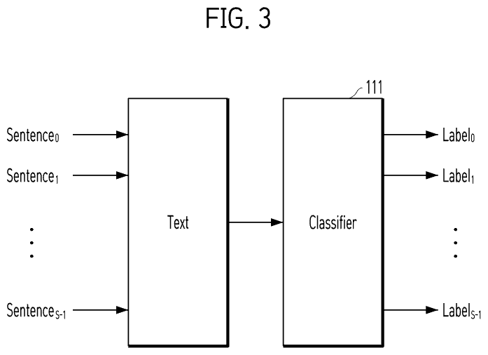

FIG. 2 is a diagram illustrating a documents analysis system in accordance with one embodiment of the present invention.

Referring to FIG. 2, the documents analysis system 100 may receive and analyze sentences of one or more large volume technical documents for a storage device. In one embodiment, the documents analysis system 100 may detect and extract multiple-sentence characteristics from a large volume technical document. The technical document includes at least one or more of a specification, a manual, a user guide and a standard, which are each associated with the storage device.

The documents analysis system 100 of FIG. 2 may perform a scheme of extracting multiple-sentence characteristics from a technical document based on the following:

(1) Since the amount of analyzed text data within the document is not fixed, multiple models (i.e., classifiers) with different context size (or context window size) S may be used to improve the quality of the documents analysis. The parameter (i.e., context size) S can vary from 2 sentences to 100 (or more) sentences depending on the amount of available text data of the document.

(2) Since the sentences within the analyzed amount of text data can be joined in different ways to form a characteristic, i.e., sequentially or non-sequentially, a multi-label approach for each model may be used.

(3) The results of a single model with fixed context window size S are worse in the majority of cases comparing to the ensemble of multiple models with different context window size S.

The documents analysis system 100 may include a plurality of classifiers and an ensemble neural network 120. In the illustrated documents analysis system 100 of FIG. 2, the plurality of classifiers may include K multi-label classifiers 110_0 to 110_(K−1). Each of the plurality of classifiers 110_0 to 110_(K−1) may receive multiple sentences for the technical document. In the illustrated documents analysis system 100 of FIG. 2, multiple models (i.e., K classifiers) with different context size S are provided. The classifier 110_0 receives sentences with a context size S_0, the classifier 110_1 receives sentences with a context size S_1, and the classifier 110_(K−1) receives sentences with a context size S_(K−1). In one embodiment, the different context windows may be determined as S₀<S₁<. . . <S_{K-1}. Each of the plurality of classifiers 110_0 to 110_(K−1) may generate multi-labels (e.g., classifier 110_0 generates S_0 labels, classifier 110_1 generates S_1 labels, classifier 110_(K−1) generates S_(K−1) labels) for the multiple sentences. Each label may indicate whether each sentence has a target characteristic (required characteristic). Each of the plurality of classifiers 110_0 to 110_(K−1) may be based on a large language model (LLM).

Referring to FIG. 3, a classifier 111 may receive a datapoint (or a text fragment) including multiple sentences (e.g., S sentences). The dataset including a single or multiple datapoints may be based on a single or multiple complete technical documents, and may have a significant amount text fragment with multiple connected sequences within the technical documents. Alternatively, a text fragment may be a paragraph, page or any other reasonable amount of text within one or more technical documents. The classifier 111 may classify the multiple sentences and generate multi-labels (e.g., S labels) for the multiple sentences based on the classification results. That is, the single or multiple technical documents may be parsed into multiple sentences (e.g., S sentences), which are linked with labels (e.g., S labels).

In one embodiment, the label value may be a binary value indicating whether the corresponding sentence has a required characteristic described in the document or not. For example, the label value (1) may mean that the corresponding sentence has the required characteristic, and the label value (0) may mean that the corresponding sentence does not have the required characteristic. In another embodiment, the range of label values may include more than two values (e.g., the required characteristic has a low (1), medium (2) or high (3) value). Alternatively, the label values may be non-integer probability values (in the range from 1 to 0) of having the characteristic.

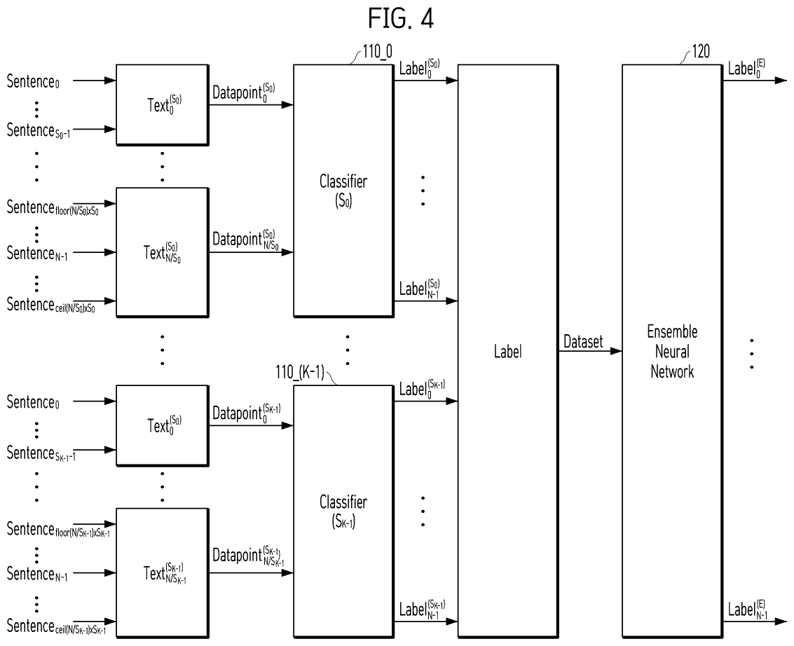

Referring to FIG. 4, multiple models may be trained on the same dataset, but split into a different number of datapoints. If a dataset has N sentences and the window size is S, the number of datapoints for a classifier is determined as a ceiling function, referred to hereinafter as ceil(N/S). Therefore, the larger context window size S is chosen, the smaller dataset is used for training process. Since different documents require different sizes for the context window, multiple (i.e., K) multi-label classifiers may be used to form an ensemble model. The ceiling function as used here is a mathematical function that rounds a real number up to the least integer that is greater than or equal to that number.

In FIG. 4, the number of datapoints for classifiers 110_0, 110_1, . . . , 110_(K−1) may be ceil(N/S₀), ceil(N/S₁), . . . , ceil(N/S_{K-1}), respectively. That is, the classifier 110_0 receives datapoints (text fragments) corresponding to the number of ceil(N/S₀). A text fragment Text₀^{(S_0)} (i.e., datapoint₀^{(S_0)}) may include multiple sentences Sentence_0 to Sentence_(S₀−1). A text fragment Text_{N/S_0}^{(S_0)} (i.e., datapoint_{N/S_0}^{(S_0)} may include multiple sentences Sentence_floor(N/S₀)×S₀ to Sentence_ceil(N/S₀)×S₀. The classifier 110_(K−1) receives datapoints (text fragments) corresponding to the number of ceil(N/S_{K-1}). A text fragment Text₀^{(S_K-1)}(i.e., datapoint₀^{(S_K-1)}) may include multiple sentences Sentence_0 to Sentence_(S_{K-1}−1). A text fragment Text_{N/S_(K-1)}^{(S_K-1)} (i.e., datapoint_{N/S_(K-1)}^{(S_K-1)} may include multiple sentences Sentence_floor(N/S_{(K-1)})×S_{(K-1)} to Sentence_ceil(N/S_{(K-1)})×S_{(K-1)}. The floor function as used here is a mathematical function that rounds a real number down to the greatest integer that is less than or equal to that number.

Each model (i.e., the classifier) may generate N labels as a training dataset for the the ensemble neural network 120: for the context window size S₀, Label₀^{(S_0)}, . . . , Label_{N-1}^{(S_0)} are generated; for the context window size S₁, Label₀^{(S_1)}, . . . , Label_{N-1}^{(S_1)} are generated; and for the context window size S_{K-1}, Label₀^{(S_(K-1))}, . . . , Label_{N-1}^{(S_(K-1))} are generated.

The classifier with Sᵢ sentences context window receives ceil(N/Sᵢ) datapoints, each of the datapoints containing Sᵢ sentences. If N is not divisible by Sᵢ, the last datapoint may be appended by {N−(floor(N/Sᵢ)×Sᵢ)} sentences with some text to make the number of sentences in the last datapoint be exactly Sᵢ.

In one embodiment, the plurality of classifiers includes: a first classifier configured to receive a first number of text fragments based on the number N of the labels and a first context size, and a second classifier configured to receive a second number of text fragments based on the number N of the labels and a second context size different from the first context size. In one embodiment, each of the first and second context sizes is variable. In one embodiment, the first number of text fragments is determined based on a ceil function between the number of the multi-labels and the first context size, and the second number of text fragments is determined based on a ceil function between the number of the multi-labels and the second context size.

All (N×K) labels may form a dataset for training the ensemble neural network 120, which tunes the weights in order to predict final K label values for each sentence based on the (N×K) labels provided by the classifiers. As a result, the ensemble neural network 120 can provide a balanced prediction of the required characteristic for the document text taking into account context windows of different size.

Referring to FIGS. 2 and 4, each of the plurality of classifiers 110_0 to 110_(K−1) may receive text fragments at different datapoints corresponding to the multiple sentences with different context window sizes, and generate the multi-labels corresponding to the text fragments. The ensemble neural network 120 may sequentially receive, as training datasets, multiple multi-labels from the plurality of classifiers 110_0 to 110_(K−1), and generate, as a result of training, multiple labels for the multiple sentences based on the training datasets. For example, the ensemble neural network 120 may generate, as a result of training, N labels Label₀^{(E)}, . . . , Label_{N-1}^{(E)}. The ensemble neural network 120 may use a model based on K models with different context windows S₀<S₁< . . . <S_{K-1}. The ensemble model may represent a machine learning technique that combines multiple models (i.e., multiple classifiers 110_0 to 110_(K−1)) to improve the accuracy of predictions.

As such, the documents analysis system 100 may detect and extract multiple sentence characteristics from large volume technical documents. In one embodiment, sequential text fragments within a particular page of a technical document (e.g., 10 sentences (sentence 1 to sentence 10) can be detected. In another embodiment, non-sequential text fragments (e.g., sentences 1, 3, 7, 8, 9 and 10) can be detected if they are classified as a required target characteristic described in the technical document. Thus, the scheme of the documents analysis system 100 is based on optimizing the results obtained from K multi-label classifiers analyzing different fixed amount of sentences S.

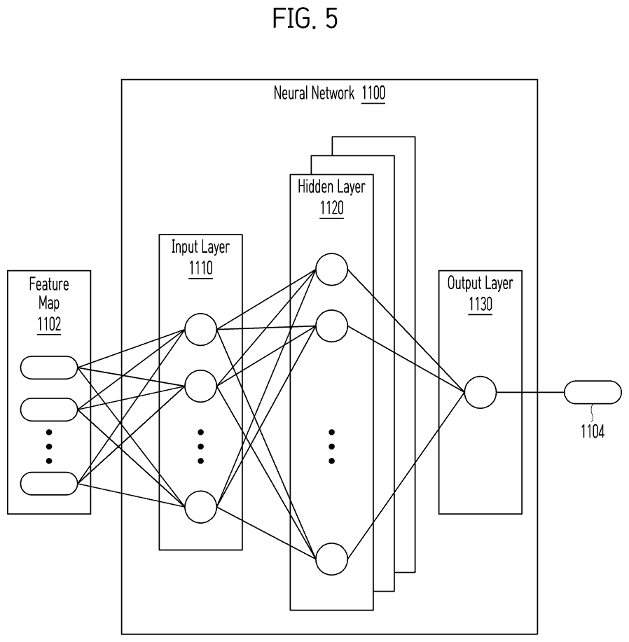

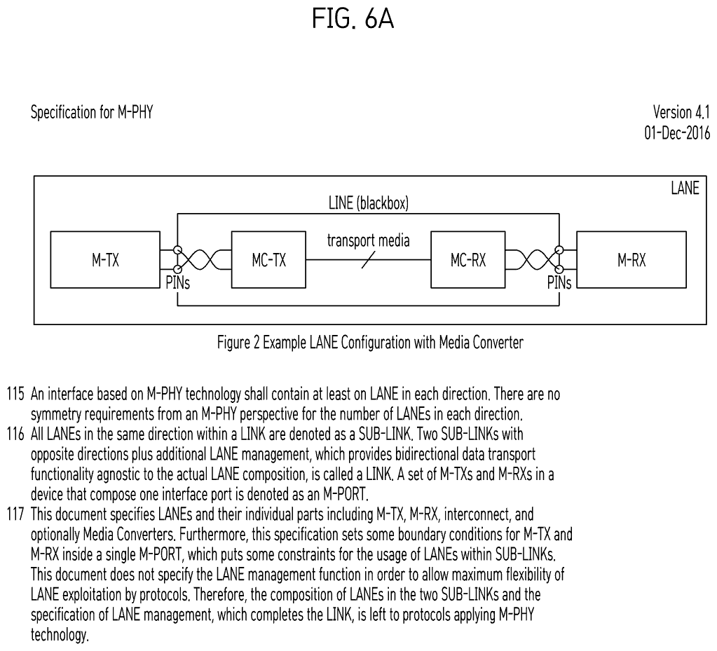

FIG. 5 is a diagram of a neural network 1100 in accordance with one embodiment of the present invention. The neural network 1100 may be implemented for the plurality of classifiers 110_0 to 110_(K−1) each configured to classify the text fragments and generate multi-labels based on a large language model (LLM). Further, the neural network 1100 may be implemented for the ensemble neural network 120.

Referring to FIG. 5, a feature map 1102 associated with one or more input conditions may input to the neural network 1100. The feature map 1102 includes one or more features associated with one or more input conditions. The neural network 1100 uses the feature map 1102 to generate and output information 1104. As illustrated, the neural network 1100 includes an input layer 1110, one or more hidden layers 1120 and an output layer 1130. Features from the feature map 1102 may be connected to input nodes in the input layer 1110. The information 1104 may be generated from an output node of the output layer 1130. One or more hidden layers 1120 may exist between the input layer 1110 and the output layer 1130. The neural network 1100 may be pre-trained to process the features from the feature map 1102 through the different layers 1110, 1120, and 1130 in order to output the information 1104.

The neural network 1100 may be a multi-layer neural network that represents a network of interconnected nodes, such as an artificial deep neural network, where knowledge about the nodes (e.g., information about specific features represented by the nodes) is shared across layers and knowledge specific to each layer is also retained. Each node represents a piece of information. Knowledge may be exchanged between nodes through node-to-node interconnections. Input to the neural network 1100 may activate a set of nodes. In turn, this set of nodes may activate other nodes, thereby propagating knowledge about the input. This activation process may be repeated across other nodes until nodes in the output layer 1130 are selected and activated.

In one embodiment, the neural network 1100 may include a hierarchy of layers representing a hierarchy of nodes interconnected in a feed-forward way. The input layer 1110 may exist at the lowest hierarchy level. The input layer 1110 as detailed below may include a set of nodes that are referred to herein as input nodes (e.g., the training dataset of FIG. 4). When the feature map 1102 is input to the neural network 1100, each of the input nodes of the input layer 1110 may be connected to each feature of the feature map 1102. Each of the connections may have a weight, each of which is derived from the training of the neural network 1100. The weights represent one set of parameters of the neural network 1100. The input nodes may transform the features by applying an activation function to these features. The information derived from the transformation may be passed to the nodes at a higher level of the hierarchy.

The output layer 1130 may exist at the highest hierarchy level. The output layer 1130 may include one or more output nodes. When the output layer 1130 outputs the output information 1104, each output node may provide a specific value of the output information 1104 (e.g., the N labels Label₀^{(E)}, . . . , Label_{N-1}^{(E)} of the ensemble neural network 120 obtained as a result of training). The number of output nodes depends on how many specific values of output information 1104 are needed. In other words, there can be a one-to-one relationship or mapping between the number of output nodes and the number of values or pieces of output information 1104.

The hidden layer(s) 1120 may exist between the input layer 1110 and the output layer 1130. There may be L hidden layer(s) 1120, where “L” is an integer greater than or equal to one. Each of the hidden layers 1120 may include a set of nodes that are referred to herein as hidden nodes. Example hidden layers may include up-sampling, convolutional, fully connected layers, and/or data transformation layers.

At the lowest level of the hidden layer(s) 1120, hidden nodes of that layer may be interconnected to the input nodes. At the highest level of the hidden layer(s) 1120, hidden nodes of that level may be interconnected to the output node. The input nodes may be not directly interconnected to the output node(s). If multiple hidden layers exist, the input nodes are interconnected to hidden nodes of the lowest hidden layer. In turn, these hidden nodes are interconnected to the hidden nodes of the next hidden layer. An interconnection may represent a piece of information learned about the two interconnected nodes. The interconnection may have a numeric weight that can be tuned (e.g., based on a training dataset), rendering the neural network 1100 adaptive to inputs and capable of learning.

Generally, the hidden layer(s) 1120 may allow knowledge about the input nodes of the input layer 1110 to be shared among the output nodes of the output layer 1130. To do so, a transformation f may be applied to the input nodes through the hidden layer 1120. In an example, the transformation f is non-linear. Different non-linear transformations f are available including, for instance, a rectifier function f(x)=max(0, x). In an example, a particular non-linear transformation f is selected based on cross-validation.

### EXAMPLES

The training dataset of FIG. 4 is based on M-PHY 4.1specification (that is the specification for a physical layer interface). The target characteristic for analysis of the documents analysis system 100 is to predict whether a given text fragment is a requirement or not in M-PHY 4.1specification. The specification has been manually analyzed for the purpose of verification by extracting requirements and designing test environment to check the correctness of the protocol operation. As a result, the specification has been split into 219 pages of text consisting 4629 sentences: 772 of the sentences are related to the requirements and 3857 of the sentences are not.

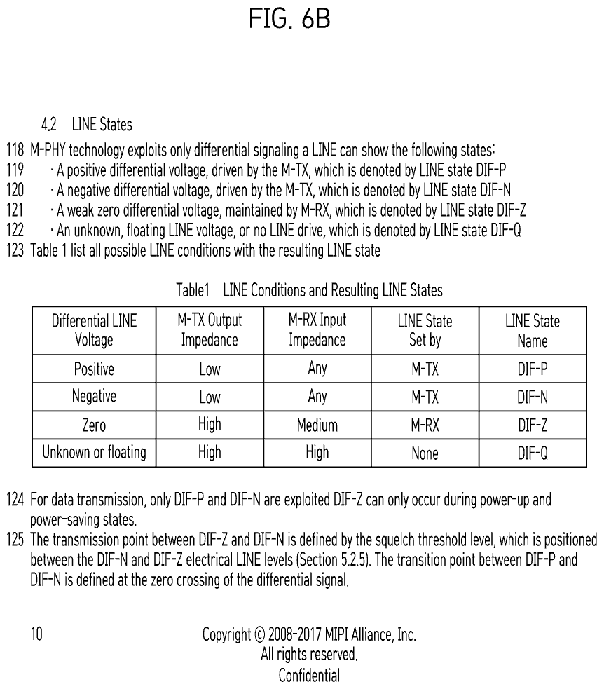

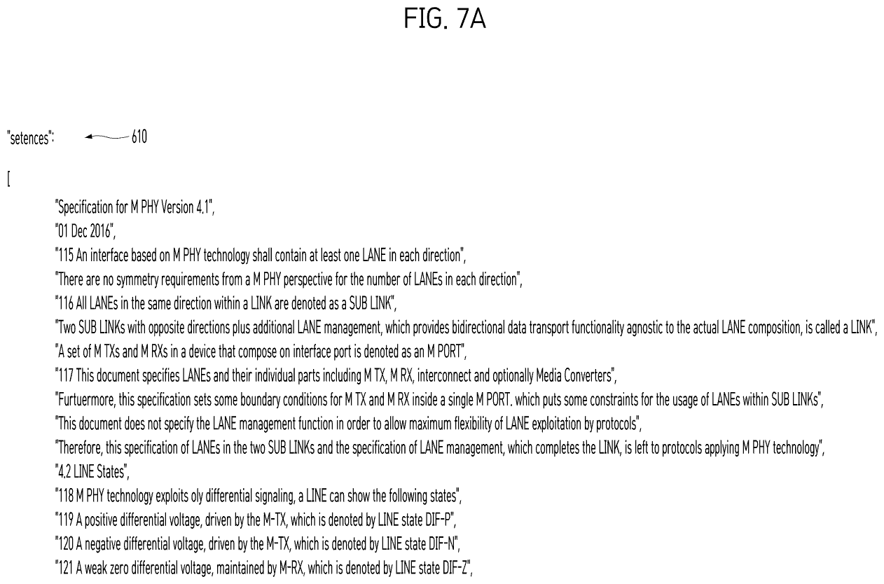

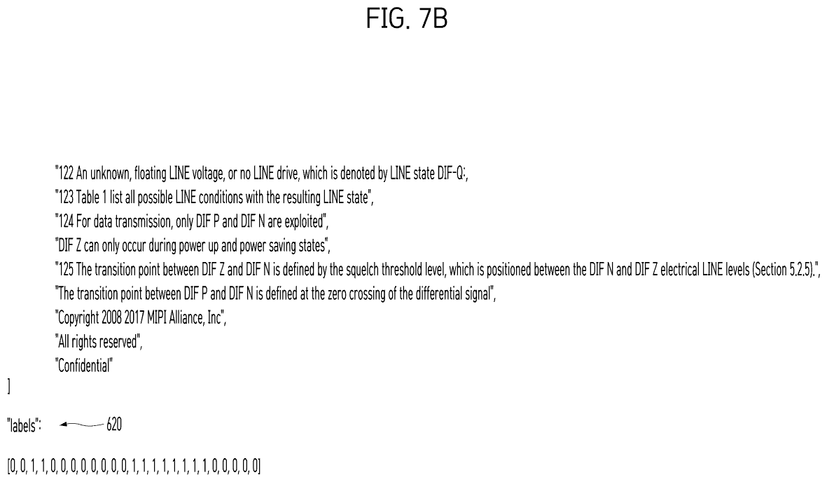

Examples of data extracted from the page 24 from M-PHY specification are shown in FIGS. 6A to 7B. FIGS. 6A and 6B illustrate page 24 of M-PHY specification, and FIGS. 7A and 7B illustrate data extraction from page 24 of M-PHY specification. In FIGS. 7A and 7B, 610 represents extracted sentences, and 620 represents labels generated by the documents analysis system.

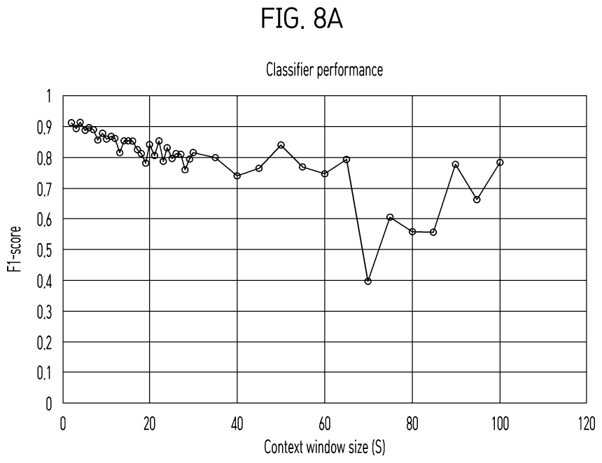

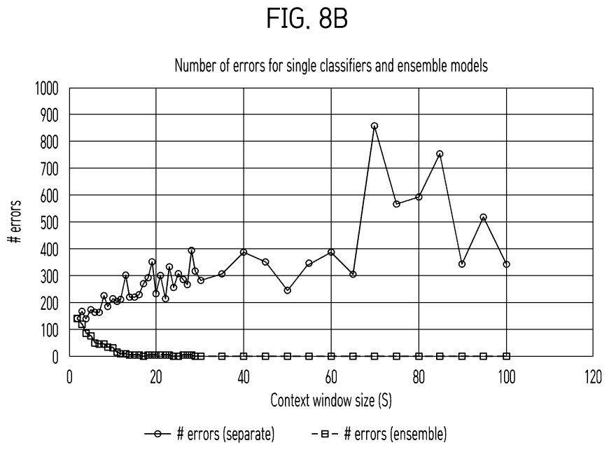

The basic element of the ensemble model (i.e., the ensemble neural network 120) is an LLM based multi-label classifier. In one embodiment, the S-label Mistral v.0.1 model has been utilized as a basic classifier. Classifiers with different parameter S={2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100} (43 classifiers) have been trained on the dataset (70% of the dataset is training data, and 30% of the dataset is validation data). The performance of trained classifiers depending on context window size S is shown in FIG. 8A. That is, in FIG. 8A, x-axis represents a context window size, and y-axis represents the performance of trained classifiers (i.e., the values of F1-score for the classifiers). The F1-scores decrease (indicating poorer performance) for larger content window sizes due to decreased number of actual datapoints. In general, values for F1-scores greater than 0.5 indicate that the model performs better than a random guessing algorithm in case of binary classification.

Since the classifiers have different sizes of a validation set (in sentences), it is hard to assess the classifiers by the same metric. Therefore, the number of erroneously classified sentences within the whole specification is chosen as a metric to compare the performance of a single classifier and an ensemble model utilizing a couple or more classifiers. Since the number of classifiers is relatively large (43), there is no possibility to compare all possible combinations (2⁴³). Instead, classifiers were combined sequentially: first, the ensemble model contains only one classifier (S={2}), second, the ensemble model contains two classifiers (S={2, 3}), third, the ensemble model contains three classifiers (S={2, 3, 4}), . . . and the 43^{th} ensemble model contains 43 classifiers (S={2, 3, . . . , 30, 35, 40, . . . , 100}.

The comparison between the number of errors for 43 single classifiers (o) and the number of errors for 43 ensemble models (□) is shown in FIG. 8B. In FIG. 8B, x-axis represents a context window size, and y-axis represents the number of errors for single classifiers and ensemble models. The ensemble models have far less errors as compared to the single classifiers, especially if the number of models with different context windows in the ensemble model is greater than 5-10.

Referring back to FIGS. 4 and 5, the architecture of the ensemble neural network 120 may be implemented with for example a 5-layer fully-connected network including one input layer, four hidden layers and one output layer (e.g., K Linear neurons (input layer)→1024 ReLU neurons (hidden layer)→512 ReLU neurons (hidden layer)→256 ReLU neurons (hidden layer)→128 ReLU neurons (hidden layer)→1 Sigmoid neuron (output layer)). ReLU represents a rectified linear unit activation function.

To achieve a negligible number of errors, it is enough to join at least K=11 classifiers to the ensemble model, which makes only 8 errors in this case. On the other hand, taking K=16 classifiers to the ensemble model provides better result, i.e., 0 errors. Thus, number of classifiers from K=11 to K=16 are optimal in terms of quality (number of errors) and size (number of classifiers used in the ensemble model). Increasing the number of classifiers to the ensemble model does not give a significant increase of performance, i.e., some of the combinations may give 1-2 errors, but the overall quality is comparable.

Unfortunately, the amount of data from one specification is not enough to provide a robust performance on unknown data. The inference of the ensemble model utilizing K=16 classifiers has been tested on the M-PHY specification v.6.0. The ensemble model recognized 100% of the requirements, which were inherited from the M-PHY v.4.1 specification, but recognized only 70% of the new requirements. These results show overfitting issues, which can be solved by using more labeled data extracted from various technical documents for the training dataset.

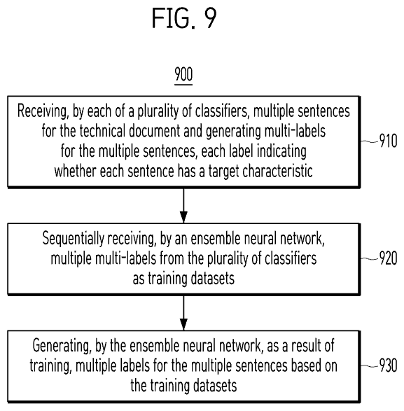

FIG. 9 is a flowchart illustrating a documents analysis method 900 in accordance with one embodiment of the present invention. The method 900 may be performed by the documents analysis system of FIGS. 2 to 4 for analyzing documents to be used for verifying a storage device.

Referring to FIG. 9, at operation 910, the method 900 may include receiving, by each of a plurality of classifiers, multiple sentences for the technical document and generating multi-labels for the multiple sentences. Each label may indicate whether each sentence has a target characteristic described in the technical document.

Operation 920 may include sequentially receiving, by an ensemble neural network, multiple multi-labels from the plurality of classifiers as training datasets.

Operation 930 may include, generating, by the ensemble neural network, as a result of training, multiple labels for the multiple sentences based on the training datasets.

The receiving of the multiple sentences may include receiving, by each of the plurality of classifiers, text fragments at different datapoints corresponding to the multiple sentences with different context window sizes, and generating the multi-labels corresponding to the text fragments.

In one embodiment, the receiving of the multiple sentences includes receiving, by a first classifier, a first number of text fragments based on the number of the multi-labels and a first context size, and receiving, by a second classifier, a second number of text fragments based on the number of the multi-labels and a second context size different from the first context size.

In one embodiment, each of the first and second context sizes is variable.

In one embodiment, the method further includes: determining the first number of text fragments based on a ceil function between the number of the multi-labels and the first context size, and determining the second number of text fragments based on a ceil function between the number of the multi-labels and the second context size.

In one embodiment, each of the plurality of classifiers classifies the text fragments and generates multi-labels based on a large language model (LLM).

In one embodiment, each label includes one of two binary values for the target characteristic.

In one embodiment, each label includes a value in a range having values more than two binary values for the target characteristic.

In one embodiment, each label includes a probability value for the target characteristic.

In one embodiment, the ensemble neural network includes a 5-layer connected network including one input layer, four hidden layers and one output layer.

In one embodiment, the technical document includes at least one or more of a specification, a manual, a user guide and a standard, which are each associated with the storage device.

As described above, embodiments of the present invention provide a scheme for analyzing a technical document for storage devices and extracting multiple-sentence characteristics from the technical document based on an ensemble learning technique with multiple multi-label classifiers. This scheme can be used for the relatively large amount of texts, and provide inputs for the engineers (verification, FW, software) to save their valuable time for the tasks with higher priority.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

What is claimed is:

1. A system for analyzing at least one technical document for a storage device, the system comprising:
a plurality of classifiers, each classifier configured to receive multiple sentences from the technical document and generate multi-labels for the multiple sentences, each label indicating whether each sentence has a target characteristic described in the technical document; and
an ensemble neural network configured to sequentially receive, as training datasets, multiple multi-labels from the plurality of classifiers, and generate, as a result of training, multiple labels for the multiple sentences based on the training datasets,
wherein each of the plurality of classifiers is configured to receive text fragments at different datapoints corresponding to the multiple sentences with different context window sizes, and generate the multi-labels corresponding to the text fragments.

2. The system of claim 1, wherein the plurality of classifiers includes:
a first classifier configured to receive a first number of text fragments based on the number of the multi-labels and a first context size, and
a second classifier configured to receive a second number of text fragments based on the number of the multi-labels and a second context size different from the first context size.

3. The system of claim 2, wherein each of the first and second context sizes is variable.

4. The system of claim 1, wherein each of the plurality of classifiers classifies the text fragments and generates multi-labels based on a large language model (LLM).

5. The system of claim 1, wherein each label includes one of two binary values for the target characteristic.

6. The system of claim 1, wherein each label includes a value in a range having values more than two binary values for the target characteristic.

7. The system of claim 1, wherein each label includes a probability value for the target characteristic.

8. The system of claim 1, wherein the ensemble neural network includes a connected network including one input layer, four hidden layers and one output layer.

9. The system of claim 1, wherein the technical document includes at least one or more of a specification, a manual, a user guide and a standard, which are each associated with the storage device.

10. A method for analyzing at least one technical document for a storage device, the method comprising:
receiving, by each of a plurality of classifiers, multiple sentences from the technical document and generating multi-labels for the multiple sentences, each label indicating whether each sentence has a target characteristic described in the technical document;
sequentially receiving, by an ensemble neural network, multiple multi-labels from the plurality of classifiers as training datasets; and
generating, by the ensemble neural network, as a result of training, multiple labels for the multiple sentences based on the training datasets,
wherein the receiving of the multiple sentences includes
receiving, by each of the plurality of classifiers, text fragments at different datapoints corresponding to the multiple sentences with different context window sizes, and
generating the multi-labels corresponding to the text fragments.

11. The method of claim 10, wherein the receiving of the multiple sentences includes
receiving, by a first classifier, a first number of text fragments based on the number of the multi-labels and a first context size, and
receiving, by a second classifier, a second number of text fragments based on the number of the multi-labels and a second context size different from the first context size.

12. The method of claim 11, wherein each of the first and second context sizes is variable.

13. The method of claim 10, wherein each of the plurality of classifiers classifies the text fragments and generates multi-labels based on a large language model (LLM).

14. The method of claim 10, wherein each label includes one of two binary values for the target characteristic.

15. The method of claim 10, wherein each label includes a value in a range having values more than two binary values for the target characteristic.

16. The method of claim 10, wherein each label includes a probability value for the target characteristic.

17. The method of claim 10, wherein the ensemble neural network includes a connected network including one input layer, four hidden layers and one output layer.

18. The method of claim 10, wherein the technical document includes at least one or more of a specification, a manual, a user guide and a standard, which are each associated with the storage device.
